(19) United States
(12) Patent Application Publication
(10) Pub. No.: US 2023/0052757 A1
(43) Pub. Date: Feb. 16, 2023

(54) SOME/IP-BASED DEBUG SYSTEM AND METHOD

(71) Applicant: iAUTO (Shanghai) Co., Ltd., Shanghai (CN)

(72) Inventors: Guang ZHOU, Shanghai (CN); Shunlong MA, Shanghai (CN)

(73) Assignee: iAUTO (Shanghai) Co., Ltd., Shanghai (CN)

(21) Appl. No.: 17/725,685

(22) Filed: Apr. 21, 2022

(30) Foreign Application Priority Data
Aug. 11, 2021 (CN) 202110918674.X

(51) Int. Cl. B60W 50/02

(52) U.S. Cl. CPC B60W 50/0205; B60W 50/0225; B60W 2556/45

(57) ABSTRACT

A Scalable service-Oriented MiddlewarE over IP (SOME/IP)-based debug system and method are provided. The SOME/IP-based debug system includes: a debug device configured to determine a debug instruction based on an input of a user; and a plurality of vehicle-mounted ECUs, where each of the vehicle-mounted ECUs includes a lower debug service configured to establish an SOME/IP communication connection with the debug device, receive the debug instruction via the SOME/IP communication connection, and execute a corresponding debug action based on the debug instruction. According to the technical solution of the present disclosure, debugging functions of vehicle-mounted ECUs can be implemented.

### CROSS REFERENCE TO RELATED APPLICATION(S)

This patent application claims the benefit and priority of Chinese Patent Application No. 202110918674.X, entitled “SOME/IP-BASED DEBUG SYSTEM AND METHOD” filed on Aug. 11, 2021, the disclosure of which is incorporated by reference herein in its entirety as part of the present application.

### TECHNICAL FIELD

The present disclosure relates to the field of computer technologies, and in particular, to a Scalable service-Oriented MiddlewarE over IP (SOME/IP)-based debug system and method.

### BACKGROUND ART

At present, an automotive electrical/electronic architecture is rapidly transforming from a distributed architecture to a domain-centralized architecture, and may realize centralization of the entire vehicle in the future. Based on rapid development of an electrical/electronic architecture, a service-oriented architecture (SOA) is proposed in the automotive industry. In the SOA architecture, functions of an automobile are divided into different services and associated by domain. Electronic control units (ECUs) may provide different services. In the SOA architecture, an SOME/IP protocol is provided in a service-oriented communication manner. The SOME/IP protocol is an IP-based extensible service-oriented middleware, and can provide a wide range of middleware functions, such as serialization, remote procedure invocation, service discovery, subscription/publication, and user datagram protocol (UDP) segmentation.

When developing in the SOA architecture, functions of the ECUs need to be debugged. At present, there is an urgent requirement for a solution capable of debugging the functions of the ECUs.

### SUMMARY

A technical problem solved by the present disclosure is how to debug a function of a vehicle-mounted ECU.

To resolve the technical problem, an embodiment of the present disclosure provides an SOME/IP-based debug system. The SOME/IP-based debug system includes: a debug device configured to determine a debug instruction based on an input of a user; and a plurality of vehicle-mounted ECUs, where each of the vehicle-mounted ECUs includes a lower debug service being configured to establish an SOME/IP communication connection with the debug device, receive the debug instruction via the SOME/IP communication connection, and execute a corresponding debug action based on the debug instruction.

Optionally, the lower debug service determines a debug response message based on an execution result of the debug action, and feeds back the debug response message to the debug device.

Optionally, the debug device is an internal debug device, and the internal debug device and the plurality of vehicle-mounted ECUs are in a same local area network.

Optionally, the debug device is an external debug device. The SOME/IP-based debug system further includes a cloud server configured to receive the debug instruction from the external debug device, and forward the debug instruction to a to-be-debugged vehicle-mounted ECU.

Optionally, the lower debug service determines the debug response message based on the execution result of the debug action, and feeds back the debug response message to the cloud server. The cloud server forwards the debug response message to the external debug device.

Optionally, the debug device includes an upper debug service and an SOME/IP protocol stack. The upper debug service is configured to determine the debug instruction based on a test case input by a user. The debug instruction includes an action request and a target service. The SOME/IP protocol stack is configured to encapsulate the debug instruction according to an SOME/IP protocol, and send the encapsulated debug instruction to the target service.

Optionally, each of the vehicle-mounted ECUs further includes an SOME/IP protocol stack configured to parse the received debug instruction, and send a debug action obtained by parsing to the lower debug service.

Optionally, the debug instruction is data in an SOME/IP format, and the debug instruction includes a plurality of bytes separately indicating a debug object and the debug action.

To resolve the technical problem, an embodiment of the present disclosure further discloses a debug method based on the SOME/IP-based debug system. The debug method includes:

determining, by the debug device, the debug instruction based on the input of the user; receiving, by the lower debug service in the vehicle-mounted ECU, the debug instruction via the SOME/IP communication connection; and executing, by the lower debug service, the corresponding debug action based on the debug instruction.

The embodiments of the present disclosure further disclose a computer-readable storage medium. The computer-readable storage medium stores a computer program. The computer program is executed by a processor to implement the steps of the debug method.

Compared with the prior art, the technical solutions of the embodiments of the present disclosure have the following beneficial effects.

In the technical solution of this application, the debug device in the SOME/IP-based debug system may determine the debug instruction based on the input. The SOME/IP communication connection is established between the debug device and the lower debug service of the vehicle-mounted ECU, so as to control debugging. According to the technical solution of the present disclosure, debugging the function of the vehicle-mounted ECU is implemented in a service-oriented manner. In addition, the user may control a debug process by using the debug device. This realizes convenience of debugging.

Further, the SOME/IP-based debug system further includes the cloud server configured to receive the debug instruction from the debug device, and forward the debug instruction to the to-be-debugged vehicle-mounted ECU. According to the technical solution of the present disclosure, the debug device is connected to the vehicle-mounted ECU based on the cloud. The debug instruction and the debug response message are forwarded based on the cloud. This implements remote control for debugging the function of the ECU, further implements convenience of debugging, and improves user experience.

### BRIEF DESCRIPTION OF THE DRAWINGS

FIG. 1 is a schematic structure diagram of an SOME/IP-based debug system according to an embodiment of the present disclosure;

FIG. 2 is a schematic structure diagram of an SOME/IP-based debug system in a specific application scenario according to an embodiment of the present disclosure;

FIG. 3 is a schematic structure diagram of an SOME/IP-based debug system in another specific application scenario according to an embodiment of the present disclosure; and

FIG. 4 is a flowchart of a debug method according to an embodiment of the present disclosure.

### DETAILED DESCRIPTION OF THE EMBODIMENTS

As described in the background art, there is an urgent requirement for a solution capable of debugging functions of ECUs.

In a technical solution of this disclosure, a debug instruction can be determined based on an input from a debug device in an SOME/IP-based debug system to establish an SOME/IP communication connection between the debug device and a lower debug service of a vehicle-mounted ECU to transmit the debug instruction, so as to control debugging. According to the technical solution of the present disclosure, the functions of the vehicle-mounted ECUs are debugged in a service-oriented manner. In addition, a user may control a debug process by using the debug device, achieving convenience of debugging.

The term “service” in this embodiment of the present disclosure may refer to a function unit or a function module.

To enable the objectives, features, and advantages mentioned above of the present disclosure to be more apparent and easily understood, the embodiments of the present disclosure will be described in detail below in conjunction with the drawings.

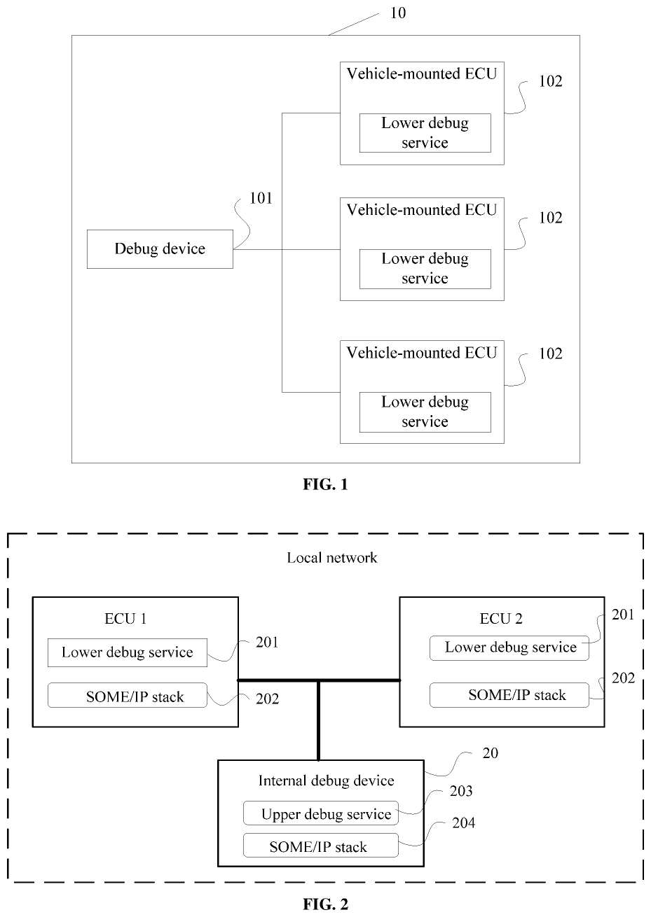

FIG. 1 is a schematic structure diagram of the SOME/IP-based debug system according to an embodiment of the present disclosure.

The SOME/IP-based debug system in this embodiment of the present disclosure may be used to debug a function of each ECU of a vehicle before the vehicle leaves a factory. For example, it is tested whether each protocol stack can establish a communication channel, whether communication support can be provided, whether routing configuration of the ECU is correct, and whether firewall configuration of the ECU is correct.

As shown in FIG. 1, the SOME/IP-based debug system may include a debug device 101 and a plurality of vehicle-mounted ECUs 102.

In this embodiment, the debug device 101 is configured to determine a debug instruction based on an input of a user.

Each vehicle-mounted ECU 102 includes a lower debug service. The lower debug service is configured to establish an SOME/IP communication connection with the debug device 101, receive the debug instruction via the SOME/IP communication connection, and execute a corresponding debug action based on the debug instruction.

In a specific implementation, the user may input information via an application program in the debug device 101, for example, to select a to-be-debugged ECU and input debug parameters. The application program may be an application program installed in the debug device 101, or may be an application program that does not need to be installed in instant messaging software, such as a WeChat applet. Specifically, the debug instruction may be determined based on a debug case (which may be alternatively referred to as a test case) selected by the user.

It should be noted that a test case is a description of a test task performed on a specific software product, and embodies a test scheme, a method, a technology, and a policy. The test case includes a test objective, a test environment, input data, a test procedure, an expected result, a test script, and the like to finally form a document. More details of the test case may refer to the prior art and are not limited in the embodiments of the present disclosure.

After receiving a debug command, the lower debug service executes a specific debug action. Specifically, a to-be-debugged protocol stack may be triggered to execute a corresponding debug action, or a query operation is executed based on a query request in the debug instruction.

In this embodiment of the present disclosure, the SOME/IP communication connection is established between the debug device and the vehicle-mounted ECU, so as to debug the vehicle-mounted ECU by the debug device.

In a non-limiting embodiment of the present disclosure, the lower debug service determines a debug response message based on an execution result of the debug action, and feeds back the debug response message to the debug device.

Specifically, different debug actions correspond to different debug response messages.

When the debug action is a route query operation, the debug response message is route information, such as a current default route of the ECU and a local area network route. When the debug action is a query operation for firewall configuration information, the debug response message is a data filtering rule and a data conversion rule of the ECU.

In a specific implementation, the vehicle-mounted ECU further includes an SOME/IP protocol stack. After the lower debug service determines the debug response message, the debug response message is encapsulated by the SOME/IP protocol stack of the vehicle-mounted ECU according to an SOME/IP protocol specification and then the encapsulated message is sent to the debug device.

For example, the debug system includes an ECU 1 and an ECU 2. A lower debug service of the ECU 1 receives a route query command sent by the debug device to query a route, and then notifies the SOME/IP protocol stack of the queried route information (the current default route, the local area network route, and the like) such that the route information is encapsulated by the SOME/IP protocol stack according to the SOME/IP protocol specification and then sent to the debug device. For another example, a lower debug service of the ECU 2 receives a firewall configuration obtaining command sent by the debug device, queries the firewall configuration information, and then notifies the SOME/IP protocol stack of the queried firewall configuration information (a data filtering rule, a data conversion rule, and the like). The firewall configuration information is encapsulated by the SOME/IP protocol stack according to the SOME/IP protocol specification and sent to the debug device.

Further, after receiving the debug response message, the debug device may analyze the debug response message to determine a debug result for reference by the user, such as a developer.

Specifically, after route configuration information (that is, the debug response message) of the target ECU 1 is obtained by using a route query debug case, whether a route configuration of the ECU 1 is correct may be determined based on a project requirement, and whether the route configuration of the ECU 1 affects data transmission in the local area network is analyzed. The user may determine, based on the debug response message, whether to update the route configuration of the ECU 1. After the firewall configuration information (that is, the debug response message) of the target ECU 2 is obtained by using a firewall query debug case, whether a firewall configuration of the ECU 2 is correct may be determined based on a project requirement, and whether any network security vulnerability exists in the firewall configuration of the ECU 2 is analyzed. The user may determine, based on the debug response message, whether to update the firewall configuration of the ECU 2.

In a non-limiting embodiment of the present disclosure, the debug device is an internal debug device, and the internal debug device and the plurality of vehicle-mounted ECUs are in a same local area network.

In a non-limiting embodiment of the present disclosure, the debug device includes an upper debug service and an SOME/IP protocol stack. The upper debug service is configured to determine the debug instruction based on a test case input by a user, and the debug instruction includes an action request and a target service. The SOME/IP protocol stack is configured to encapsulate the debug instruction according to the SOME/IP protocol, and send an encapsulated debug instruction to the target service.

Specifically, the action request may be a query request, or may be another action execution request, such as a setting request or a program execution request. This is not limited in this embodiment of the present disclosure.

FIG. 2 can be referred to for details. An internal debug device 20 may be connected to the ECU 1 and the ECU 2 through the Ethernet. To be specific, the internal debug device 20 may send a debug instruction (or referred to as debug data) to a target ECU through the Ethernet. An upper debug service 203 is an implementation program of a debug case, and may send debug data based on a debug case selected by a developer. An SOME/IP protocol stack 204 may encapsulate the debug data sent by the upper debug service 203 according to the SOME/IP protocol and send encapsulated debug data.

For the upper debug service 203, a plurality of debug cases may be built and developed based on project scenarios, including, but not limited to, a network debug case, a firewall debug case, and a trace log debug case. In an actual debug process, a developer may select one or more debug cases among them. The upper debug service 203 sends specific debug request data (that is, a debug instruction) to the ECU (the ECU 1 or the ECU 2) based on a debug case selected by the developer, and then receives and displays a debug response message returned by the ECU.

A lower debug service 201 of the ECU may parse a debug instruction, execute a debug action, and generate a debug response message. An SOME/IP protocol stack 202 of the ECU encapsulates the debug response message according to the SOME/IP protocol and sends the encapsulated debug response message.

For example, the developer selects the route query debug case, to set a target service as the lower debug service of the ECU 1. The upper debug service sends a route information query request to the ECU 1 based on the debug case, and then receives and displays route query reply information returned by the ECU 1. For another example, the developer selects the firewall query debug case, to set the lower debug service in the ECU 2 as a debug target. The upper debug service sends a firewall query request to the ECU 2 based on the debug case, and then accepts and displays firewall query reply information returned by the ECU 2.

In a non-limiting embodiment of the present disclosure, the debug device is an external debug device. The SOME/IP-based debug system further includes a cloud server configured to receive the debug instruction from the external debug device, and forward the debug instruction to a to-be-debugged vehicle-mounted ECU.

The embodiment of the present disclosure differs from the foregoing embodiment in that the debug device is connected to the vehicle-mounted ECU based on the cloud. A debug instruction and a debug response message are forwarded based on the cloud to implement remote control for debugging a function of the ECU, further implement convenience of debugging, and improve user experience.

Correspondingly, the cloud server may further forward the debug response message. The lower debug service determines a debug response message based on an execution result of the debug action, and feeds back the debug response message to the cloud server. The cloud server forwards the debug response message to the external debug device.

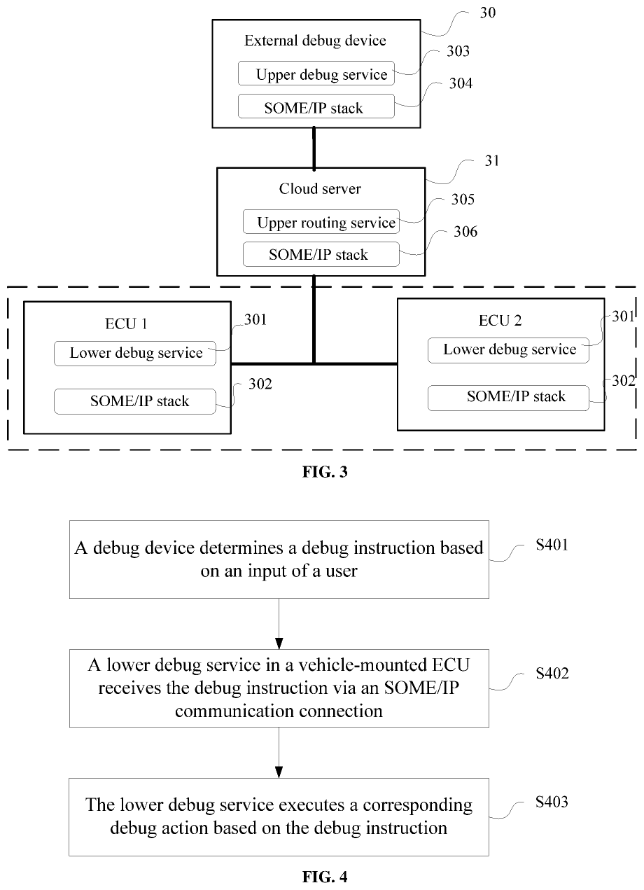

For details, refer to FIG. 3. An external debug device 30 includes an upper debug service 303 and an SOME/IP protocol stack 304. The upper debug service 303 determines specific debug request data (that is, a debug instruction) based on a debug case selected by a developer, encapsulates the specific debug request data according to the SOME/IP protocol by using the SOME/IP protocol stack 304, and sends encapsulated debug request data to the cloud server 31.

A cloud server 31 may receive and forward SOME/IP data sent by the external debug device 30. Modules deployed in the cloud server 31 include an upper routing service 305 and an SOME/IP protocol stack 306. The SOME/IP protocol stack 306 defines a service-oriented communication manner, and may parse received SOME/IP data, to obtain target service information of debug data, for example, a lower debug service 301 in the ECU 1 or a lower debug service 302 in the ECU 2. The upper routing service 305 sends the received debug data to a specific ECU (the ECU 1 or the ECU 2) based on the target service information. Similarly, the upper routing service 305 may also parse SOME/IP debug reply data sent by the ECU (the ECU 1 or the ECU 2), and forward the SOME/IP debug reply data to the upper debug service 303 in the external debug device 30.

The lower debug service 301 of the ECU may parse a debug instruction, execute a debug action, and generate a debug response message. An SOME/IP protocol stack 302 of the ECU encapsulates the debug response message according to the SOME/IP protocol and sends the encapsulated debug response message. The ECU 1 and the ECU 2 may be regarded as target ECU devices, that is, devices that may be debugged in the local area network.

In a specific application scenario, the cloud server 31 receives route information query data sent by the external debug device 30. The SOME/IP protocol stack 306 in the cloud server 31 notifies the upper routing service 305 of target service information (the lower debug service 301 in the ECU 1) and debug commands that are obtained by parsing. The upper routing service 305 forwards a route information query request to the ECU 1.

In another specific application scenario, the cloud server 31 receives route query information reply data sent by the ECU 1. The SOME/IP protocol stack 306 in the cloud server 31 notifies the upper routing service 305 of target service information (the upper debug service 303 in the external debug device 30) and route query reply information that are obtained by parsing. The upper routing service 305 forwards route information query reply information to the external debug device 30.

In still another specific application scenario, an Ethernet protocol stack in a target ECU may be remotely debugged by using a WeChat applet (that is, the debug device), a cloud server, and an SOME/IP protocol stack. Debuggable protocol stacks include an SOME/IP protocol stack, a DoIP protocol stack, an XCP protocol stack, and a DDS protocol stack.

Referring to FIG. 4, an embodiment of the present disclosure further discloses a debug method. The debug method may be performed by the debug system in the foregoing embodiments.

Specifically, the debug method may include steps S401-S403:

Step S401: A debug device determines a debug instruction based on an input of a user.

Step S402: A lower debug service in a vehicle-mounted ECU receives the debug instruction via an SOME/IP communication connection.

Step S403: The lower debug service executes a corresponding debug action based on the debug instruction.

It should be noted that a sequence number of each step in this embodiment does not limit an execution sequence of each step.

Further, the method further includes the following step: The lower debug service determines a debug response message based on an execution result of the debug action, and feeds back the debug response message to the debug device.

Further, the debug device is an external debug device. After step S401, the debug method can further include the following steps: The external debug device sends a debug instruction to a cloud server. The cloud server receives the debug instruction from the external debug device, and forwards the debug instruction to a to-be-debugged vehicle-mounted ECU.

More specific implementations of the debug method can refer to the foregoing embodiments. Details are not described herein.

An embodiment of the present disclosure further discloses a storage medium. The storage medium is a computer-readable storage medium. The computer-readable storage medium stores a computer program. The steps of the access control method shown in FIG. 4 may be performed when the computer program runs. The storage medium may include a read only memory (ROM), a random access memory (RAM), a magnetic disk, an optical disc, or the like. The storage medium may further include a non-volatile memory, a non-transitory memory, or the like.

It should be understood that, in the embodiments of this application, the processor may be a central processing unit (CPU), or the processor may be a general-purpose processor, a digital signal processor (DSP), an application-specific integrated circuit (ASIC), a field-programmable gate array (FPGA) or another programmable logic device, discrete gates or transistor logic devices, discrete hardware components, or the like. The general-purpose processor may be a microprocessor, or the processor may be any conventional processor.

Some or all of the foregoing embodiments may be implemented by software, hardware, firmware, or any combination thereof. When software is used to implement the foregoing embodiments, some or all of the foregoing embodiments may be implemented in a form of a computer program product. The computer program product includes one or more computer instructions or computer programs. When the computer instructions or the computer programs are loaded or executed on a computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired or wireless manner.

In several embodiments provided in this application, it should be understood that the disclosed method, apparatus, and system may be implemented in other manners. For example, the described apparatus embodiments are merely examples. For example, the division of units is merely a logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate. Parts shown as units may or may not be physical units, which may be located in one position, or may be distributed on a plurality of network units. Some or all of the units may be selected according to actual requirements to achieve the objectives of the solutions in the embodiments.

In addition, functional units in the embodiments of the present disclosure may be integrated into one processing unit, or each of the units may exist alone physically, or two or more units may be integrated into one unit. The integrated unit may be implemented in a form of hardware, or may be implemented in a form of hardware plus software functional units.

Although being disclosed as described above, the present disclosure is not limited to this. Any skilled in the art can make various changes and modifications without departing from the spirit and scope of the present disclosure. Therefore, the protection scope of the present disclosure shall be subject to the scope defined by the claims.

What is claimed is:

1. A Scalable service-Oriented MiddlewarE over IP (SOME/IP)-based debug system, comprising:
a debug device configured to determine a debug instruction based on an input of a user; and
a plurality of vehicle-mounted electronic control units (ECUs), wherein each of the vehicle-mounted ECUs comprises a lower debug service configured to establish an SOME/IP communication connection with the debug device, receive the debug instruction via the SOME/IP communication connection, and execute a corresponding debug action based on the debug instruction.

2. The SOME/IP-based debug system according to claim 1, wherein the lower debug service determines a debug response message based on an execution result of the debug action, and feeds back the debug response message to the debug device.

3. The SOME/IP-based debug system according to claim 1, wherein the debug device is an internal debug device, and the internal debug device and the plurality of vehicle-mounted ECUs are in a same local area network.

4. The SOME/IP-based debug system according to claim 1, wherein the debug device is an external debug device, and the SOME/IP-based debug system further comprises:
a cloud server configured to receive the debug instruction from the external debug device, and forward the debug instruction to a to-be-debugged vehicle-mounted ECU.

5. The SOME/IP-based debug system according to claim 4, wherein the lower debug service determines a debug response message based on an execution result of the debug action, and feeds back the debug response message to the cloud server, and the cloud server forwards the debug response message to the external debug device.

6. The SOME/IP-based debug system according to claim 1, wherein the debug device comprises:
an upper debug service configured to determine the debug instruction based on a test case input by a user, wherein the debug instruction comprises an action request and a target service; and
an SOME/IP protocol stack configured to encapsulate the debug instruction according to an SOME/IP protocol, and send the encapsulated debug instruction to the target service.

7. The SOME/IP-based debug system according to claim 1, wherein each of the vehicle-mounted ECUs further comprises:
an SOME/IP protocol stack configured to parse the received debug instruction, and send a debug action obtained by parsing to the lower debug service.

8. The SOME/IP-based debug system according to claim 1, wherein the debug instruction is data in an SOME/IP format, and the debug instruction comprises a plurality of bytes separately indicating a debug object and the debug action.

9. A debug method based on the SOME/IP-based debug system according to claim 1, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

10. A debug method based on the SOME/IP-based debug system according to claim 2, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

11. A debug method based on the SOME/IP-based debug system according to claim 3, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

12. A debug method based on the SOME/IP-based debug system according to claim 4, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

13. A debug method based on the SOME/IP-based debug system according to claim 5, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

14. A debug method based on the SOME/IP-based debug system according to claim 6, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

15. A debug method based on the SOME/IP-based debug system according to claim 7, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

16. A debug method based on the SOME/IP-based debug system according to claim 8, comprising:
determining, by the debug device, the debug instruction based on the input of the user;
receiving, by the lower debug service in the vehicle-mounted ECU, the debug instruction via the SOME/IP communication connection; and
executing, by the lower debug service, the corresponding debug action based on the debug instruction.

17. A computer-readable storage medium storing a computer program, wherein steps of the debug method according to claim 9 are performed when the computer program is run by a processor.

18. A computer-readable storage medium storing a computer program, wherein steps of the debug method according to claim 10 are performed when the computer program is run by a processor.

19. A computer-readable storage medium storing a computer program, wherein steps of the debug method according to claim 11 are performed when the computer program is run by a processor.

20. A computer-readable storage medium storing a computer program, wherein steps of the debug method according to claim 12 are performed when the computer program is run by a processor.
